(19) United States
(12) Patent Application Publication
(10) Pub. No.: US 2015/0095319 A1
(43) Pub. Date: Apr. 2, 2015

(54) Query Expansion, Filtering and Ranking for Improved Semantic Search Results Utilizing Knowledge Graphs

(71) Applicant: Microsoft Corporation, Redmond, WA (US)

(72) Inventors: Justin Ormont, Mountain View, CA (US); Marc Eliot Davis, San Francisco, CA (US)

(73) Assignee: Microsoft Corporation, Redmond, WA (US)

(21) Appl. No.: 14/039,259

(22) Filed: Sep. 27, 2013

(51) Int. Cl. G06F 17/30

(52) U.S. Cl. CPC G06F 17/30554; G06F 17/30424
USPC 707/723; 707/722

(57) ABSTRACT

Presented are systems and methods, as well as computer-readable media, for obtaining search results according to an expanded search query that is automatically generated from the received search query. An expanded search query is generated according to the received search query, the related entity data, and the determined search model. According to various embodiments, in response to receiving a search query, an entity is identified from the search query. Related entity data that is related to the identified entity is obtained. A search model for obtaining search results for the identified entity is determined. An expanded search query is generated for the received search query. Search results matching the expanded search query are identified and a search results presentation is generated according to the matching search results. The search results presentation is returned in response to the search query.

### CROSS-REFERENCE TO RELATED APPLICATIONS

The present application is related to U.S. patent application Ser. No. 13/931,922, filed on Jun. 29, 2013, entitled “Improved Person Search Utilizing Entity Expansion” [attorney docket no. 338965.01]; and U.S. patent application Ser. No. 13/913,835, filed on Jun. 10, 2013, entitled “Improved News Results through Query Expansion”.

### BACKGROUND

In a typical search paradigm where a computer user is searching for content relating to a particular “topic,” the computer user submits a search query to a search engine and, in response, the search engine identifies a set of search results, typically in the form of hyperlinks to content available to the computer user throughout the Internet and returns the search results to the computer user. The search query that the computer user submits is typically a string of text that includes various terms and phrases and that identifies (to a greater or lesser degree of specificity) the subject matter that is sought.

As the search query is generally comprised of a string of text, to provide search results relevant to the search query, the search engine must parse the text, determine (to the greatest extent possible) what the computer user is requesting, identify related and relevant results, generate one or more search results pages based on the identified results, and return at least the first of the search results pages to the computer user. All of this must be completed in the matter of one or two seconds in order to keep the computer user satisfied such that the computer user will return to use the search engine when submitting additional search queries.

While much has been done by search engine providers in identifying highly relevant search results to a search query, there are still many times that a search engine provides search results are not relevant (or that are less relevant) to what the computer user is seeking. Indeed, using a string of text to represent an entity is inherently ambiguous, having both low identification precision and content recall. Moreover, typically the content index of a search engine is indexed according to string found in the content: again highly ambiguous. A superior manner of identification is from searching based on entities, or mapping queries to entities.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to various embodiments, in response to receiving a search query, an entity is identified. Related entity data that is related to the identified entity is obtained. A search model for obtaining search results for the identified entity is determined. An expanded search query is generated for the received search query. The expanded search query is generated according to the received search query, the related entity data, and the determined search model. The expanded search query includes a search query segment and at least one of a disambiguation segment, an alias segment, and a filter segment. Search results matching the expanded search query are identified and a search results presentation is generated according to the matching search results. The search results presentation is returned in response to the search query.

According to additional aspects of the disclosed subject matter, a computer-readable medium bearing computer-executable instructions is presented. In execution on a computing system comprising at least a processor executing the instructions retrieved from the medium, a method is carried out for providing improved search results in response to receiving a search query. An entity of the search query is identified. Related entity data is obtained. The related entity data comprises a plurality of related entities that are related to the identified entity of the search query. A search model is determined for obtaining search results for the identified entity. An expanded search query is generated according to the received search query, the related entity data, and the search model. The expanded search query comprises a search query segment and at least one of a disambiguation segment, an alias segment, and a filter segment, wherein the search query segment includes a query term for the identified entity. Further, the at least one of the disambiguation segment, the alias segment, and the filter segment includes a query term not included in the received search query. Search results for the expanded search query are obtained. A search results presentation is generated according to the obtained search results and the search results presentation is provided in response to the received search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram of a networked environment suitable for implementing aspects of the disclosed subject matter;

FIG. 2 is a flow diagram illustrating an exemplary routine for providing improved results in response to a search query regarding content for a particular person through query expansion;

FIG. 3 is a flow diagram illustrating an exemplary routine for generating an expanded search query according to aspects of the disclosed subject matter;

FIGS. 4A and 4B illustrates exemplary search results presentations of results directed to a search query;

FIGS. 5A-5E illustrate various exemplary expanded search queries;

FIG. 6 is a block diagram illustrating exemplary components of a search engine configured to provide improved results in response to a search query from a computer user; and

FIG. 7 is a pictorial diagram illustrating an exemplary entity graph of nodes and relationships.

### DETAILED DESCRIPTION

For purposed of clarity, the use of the term “exemplary” in this document should be interpreted as serving as an illustration or example of something, and it should not be interpreted as an ideal and/or a leading illustration of that thing.

Regarding the term “entity,” an entity corresponds to a specific, identifiable thing in a corpus of things/entities. An entity may be an abstract concept or tangible item including, by way of illustration and not limitation: a person, a place, a group, an organization, a cause, a company, an activity, an event or occurrence, and the like. An entity can be specifically and uniquely identified or distinguished among the corpus of entities. While an entity may be specifically and uniquely identified among the corpus of entities, an entity may be referenced by any number of aliases. For example, and entity for the company “Microsoft Corporation” may be referenced by the aliases “Microsoft Corporation,” “Microsoft Corp.,” “Microsoft,” and “MSFT.” An entity may be an atomic unit or comprised of sub-components, each sub-component being an entity. For example, “Microsoft Corporation” is comprised of many divisions and provides numerous products and services, each of which is an entity. An entity may also be assigned a globally unique identifier (also referred to as a GUID), the GUID being unique within the corpus of entities.

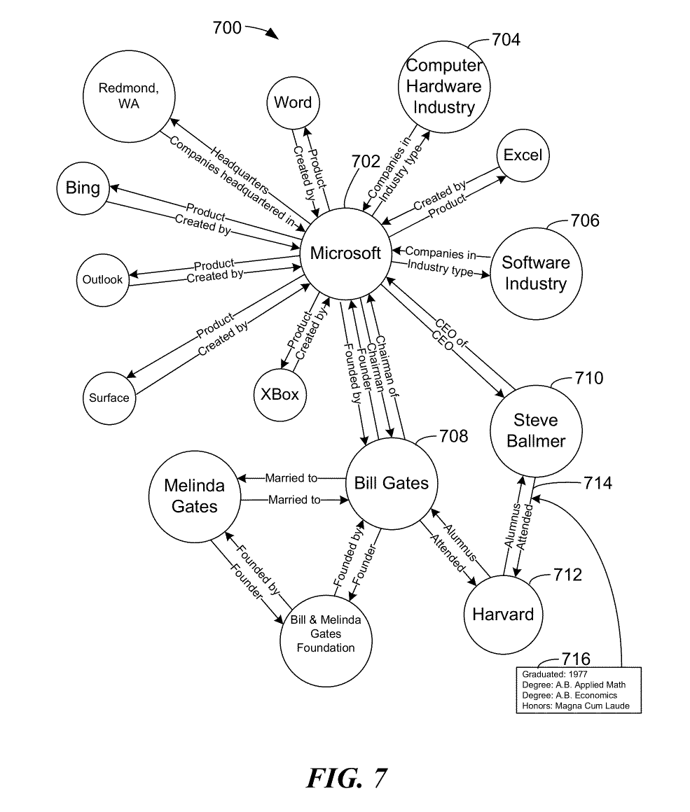

The corpus of entities is often maintained, or at least represented, as an entity graph. An entity graph is a collection of nodes (entities) interconnected by way of edges. An interconnection/edge between two nodes/entities represents a relationship of some type between the two entities. In regard to the example above, the entity/node for Microsoft Corporation may have edges to a number of other entities, such as Xbox, Windows, Bing, Excel, and the like, indicating that these other entities are “products of” Microsoft Corporation, with the “products of” being at least one relationship between Microsoft Corporation and the other entities. Of course, the entity/node for Microsoft Corporation may have additional edges to people, with the connection type corresponding to company executives, such as Bill Gates and/or Steve Ballmer. Examples of entity graphs include Microsoft Corporation's Satori and Google's Knowledge Graph, or Facebook's semantic graph. FIG. 7 is a pictorial diagram illustrating an exemplary entity graph 700. As can be seen, entity 702 corresponding to Microsoft Corporation is connected to many other entities, such as the computer hardware industry entity 704 and software industry 706. The lines between the entities represent a relationship of some type. Typically, though not exclusively, the type of relationship between two entities is not the same. For example, the relationship originating from computer hardware industry entity 704 to the Microsoft entity 702 may be one of “companies in,” as in Microsoft is a company in the computer hardware industry, whereas the relation originating from the Microsoft entity to the computer hardware industry entity is one of “is a member of.” Also shown are entities 708-710, corresponding to “Bill Gates” and “Steve Ballmer,” having a relationship with the Microsoft entity 702. These relationships may correspond to “founder” and “CEO” respectively. Further, as can be seen, both of entities 708 and 710 have a relationship with entity 712 corresponding to “Harvard.” Indeed, both Bill Gates (entity 708) and Steve Ballmer (entity 710) attended Harvard (entity 712), which is also where the two met. Further still, a relationship may be viewed as an entity. For example, the relationship 714 “attended” corresponding to the Steve Ballmer entity 710 has additional metadata 716 that further defines the nature of the relationship.

As can be seen, the entity graph 700 includes many other entities and relationship beyond those described above. Moreover, it should be appreciated that this entity graph 700 is simplified for illustration purposes. Of course, in an actual entity graph there may be billions (or more) of entities with many times that many relationships. Moreover, entities may be related based on more than one relationship. Thus, the illustrated entity graph 700 should be viewed as illustrative and should not be viewed as limiting upon the disclosed subject matter.

An entity may be associated with any number of categories. Moreover, each category is typically an entity in the entity graph. By way of illustration and not limitation, the entity Microsoft Corporation may be associated with the categories such as Software Provider, Hardware Provider, Online Services Provider, and the like. Each category is typically associated with qualities and/or aspects that are representative of the category, and these associations are similarly represented in the entity graph, where each quality or aspect is an entity and has a relationship to the category. According to aspects of the disclosed subject matter, a category may be associated with all of the qualities and/or aspects that define the category though any given entity of that category may or may not have all of the qualities of the category.

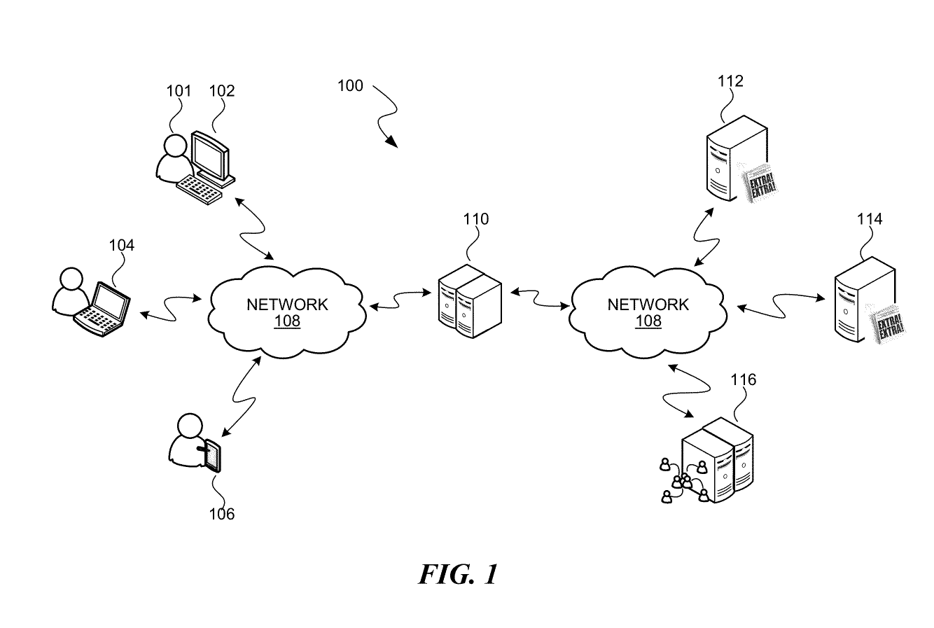

Turning to FIG. 1, FIG. 1 is a block diagram illustrating an exemplary networked environment 100 suitable for implementing aspects of the disclosed subject matter, particularly in regard to providing improved search results through entity expansion. The exemplary networked environment 100 includes one or more user computers, such as user computers 102-106, connected to a network 108, such as the Internet, a wide area network or WAN, and the like. User computers include, by way of illustration and not limitation: desktop computers (such as desktop computer 104); laptop computers (such as laptop computer 102); tablet computers (such as tablet computer 106); mobile devices (not shown); game consoles (not shown); personal digital assistants (not shown); and the like. User computers may be configured to connect to the network 108 by way of wired and/or wireless connections. For purposes of illustration only, the exemplary networked environment 100 illustrates the network 108 as being located between the user computers 102-106 and the search engine 110, and again between the search engine 110 and the network sites 112-116. This illustration, however, should not be construed as suggesting that these are separate networks.

Also connected to the network 108 are various networked sites, including network sites 110-116. By way of example and not limitation, the networked sites connected to the network 108 include a search engine 110 configured to respond to search queries, news sources 112 and 114 which host various news articles and network available content, a social networking site 116, and the like. A computer user, such as computer user 101, may navigate via a user computer, such as user computer 102, to these and other networked sites to access content, including news content. Similarly, content stored at the various networked sites may be accessed by a computer user via a user computer.

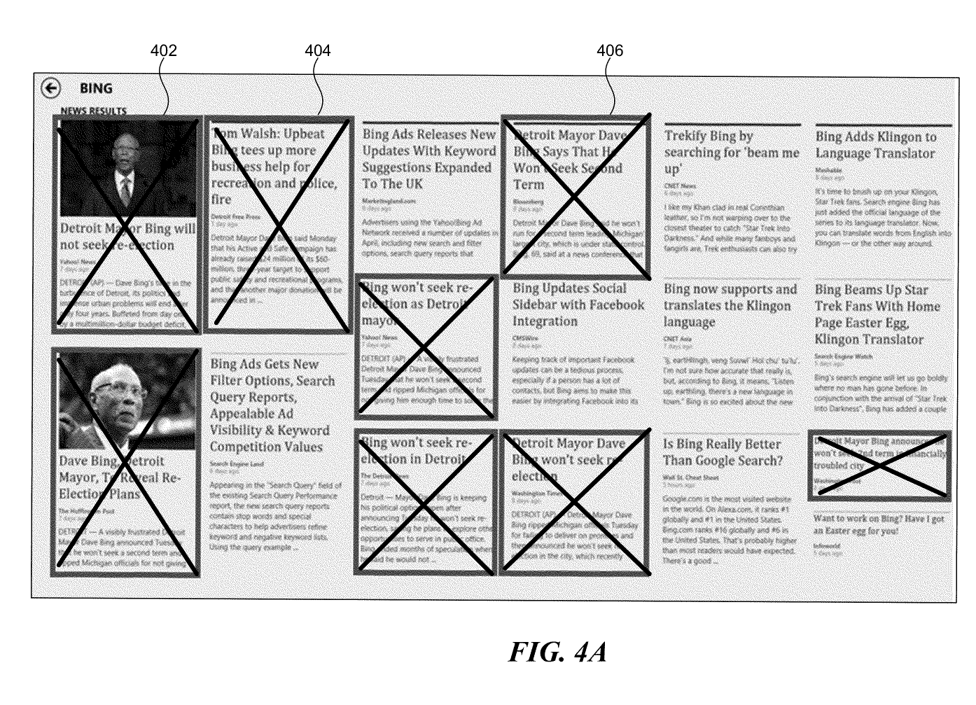

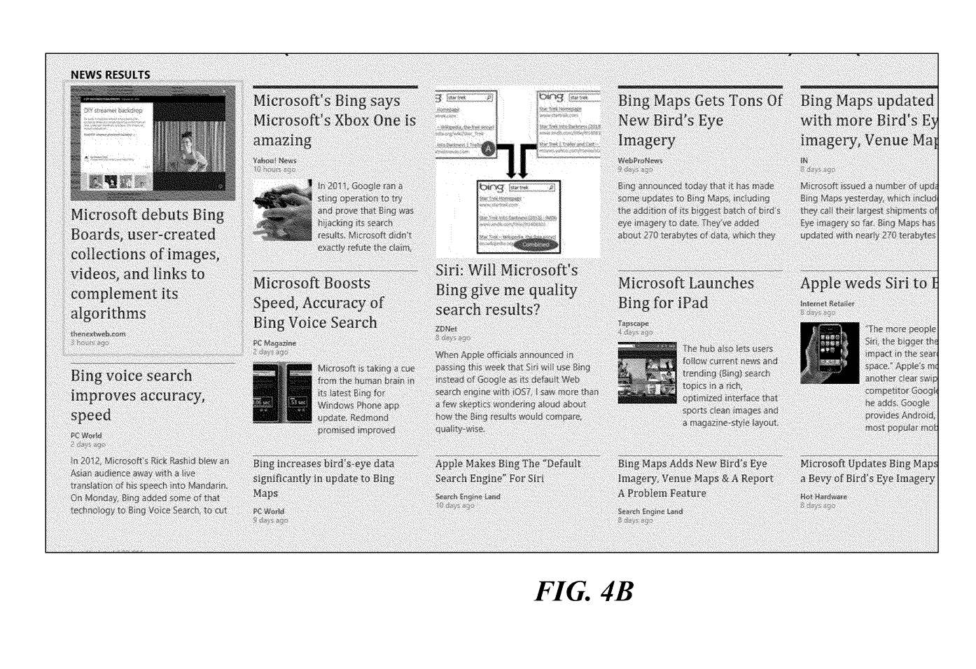

According to aspects of the disclosed subject matter, the search engine 110 is configured to provide search results (typically in the form of references to content available on the network 108) in response to a search query, including search query from a computer users as well as search queries that may be automatically generated. Indeed, a query may be generated and submitted by an automatic content delivery service (such as a news service as illustrated in FIGS. 4A and 4B), a system that conducts predictive queries on behalf of a user, or a service that periodically executes a standing query which may have been established by a computer user. Indeed, while much of the subsequent discussion is made in regard to the “typical” search query—where a computer user submits a query to a search engine and obtains results in a synchronous manner—it is illustrative and should not be viewed as limiting upon the disclosed subject matter. Hence, in response to receiving a query for content regarding an entity (irrespective of the originator of the query), the search engine 110 generates an expanded search query (as described below), identifies content related to the entity using the expanded search query, generates a search results presentation based on at least some of the identified content, and provides the search results presentation as a response to the search query.

FIG. 1 also illustratively includes a social network site 116 and various news sources, including news sites 112-114. As will be readily appreciated, a social network site 116 is an online site/service that provides a platform in which a computer user can establish a profile describing various aspects of the user, build relationships and social networks with other computer users, groups, and the like. In a social network site 116, a computer user can establish or indicate various interests, activities, and backgrounds with those in his/her social network. Indeed, those skilled in the art will appreciate that a computer user is often able to indicate a preference or an interest in a particular entity on a social networking service as might be hosted by social networking site 116, whether that entity is a person, a place, a group, a concept, an activity, and the like. Though only one social network site 116 is included in the illustrative network environment 100, this is merely illustrative and should not be viewed as limiting upon the disclosed subject matter. In an actual embodiment, there may be any number of social network sites connected to the network 108.

As is known in the art, the search engine 110 is configured to communicate (directly or indirectly through services calls and/or web crawlers) with multiple content sources, including news sites 112 and 114, social networking site 116, and other sites such as blogs and registries (not shown) to obtain information regarding the content that is available at each network site. This information is stored (typically as references to the content) in a content store such that the search engine can obtain content from this content store in order to respond to a search query from a computer user, such as computer user 101. The search engine 110 may also obtain information regarding any given individual from search query logs, network browsing histories, purchase histories, and the like. This information and the content obtained from the various network sites is typically indexed according to key words and phrases such that the information may be quickly identified and accessed. Further, in addition to information that is stored in the search engine's content store, a search engine 110 may also be configured to obtain information from other network sites when responding to a search query. For example, according to aspects of the disclosed subject matter, when responding to a search query, the search engine 110 may obtain data from one or more social networking sites, such as social network site 116, as relevant information to return to the requesting computer user and/or as information to assist the search engine in identifying relevant information to return to the requesting computer user.

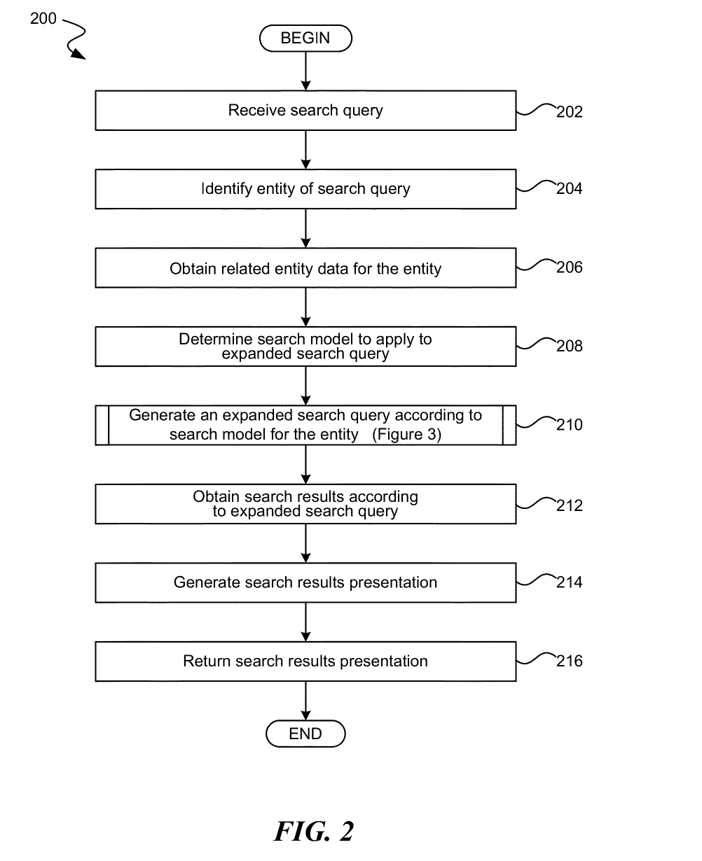

To further illustrate aspects of the disclosed subject matter, reference is now made to FIG. 2. FIG. 2 is a flow diagram of an exemplary routine 200 for providing improved results in response to a search query. Beginning at block 202, the search engine 110 receives a search query for content corresponding to subject matter identified in the query.

As will be readily appreciated, a search query is typically (though not exclusively) a text string. For example, a search query for content relating to a person may be “Bruce Wayne.” Accordingly, as there may be several individuals who have the same name, at block 204, the search engine attempts to uniquely identify the person who is the subject matter of the search query. According to aspects of the disclosed subject matter, the search engine attempts to uniquely identify the entity for which content is requested. As those skilled in the art will appreciate, mapping a text string to an entity is also known as a semantic mapping, and therefore the process is one of a semantic search.

This identification is based according to at least general information and specific information relating to the requesting party, such as a computer user. The general information includes, by way of illustration and not limitation: popularity of search queries corresponding to the entity identified in the search query; trending popularity of an entity with the name identified in the search query; other terms and/or phrases in the search query (e.g., “Bruce Wayne Seattle” or “Bruce Wayne Microsoft”); an image representative of the entity; and the like. Specific information relating to the requesting party may include, by way of illustration and not limitation: the current location of the requesting party; prior search query history of the party; current and former workplaces; current and former educational institutions that were attended; social networks; preferences (both explicitly and implicitly identified); general graph connectivity between the requesting computer user and potential subjects of a search query as well as the number of mutual friends; physical distance between the requesting user and the potential subjects; location of friends; former locations; as well as real-world, current data such as current events, the number of people discussing the matter, and the like. Those skilled in the art will appreciate that identifying the entity or entities that are the subject matter of the search query is known in the art.

Of course, the order presented in blocks 202 and 204 should be viewed as illustrative and not limiting upon the disclosed subject matter. Under various conditions, the identity of an entity for which content is sought may be known prior to submitting/receiving a search request. For example, auto-suggest search recommendations may indicate a specific entity as one of the auto-suggestions and, in many cases, the GUID of the entity would be known and can be included in the search query (if selected). Alternatively, another service may submit a search query for content related to an entity where the search query uniquely identities the entity (even by way of the entity's GUID) to the search service. Accordingly, while a particular embodiment is disclosed in regard to blocks 202 and 204 of FIG. 2, this should be viewed as illustrative and not limiting upon the disclosed subject matter.

In regard to the search request identifying an entity for whom content is sought, there may also be times in which the name of that entity is not known but some information is provided that may lead to uniquely identifying the entity. For example, the computer user may not know the name of the general manager of the Seattle Seahawks, but in submitting the text “general manager of the Seattle Seahawks” the computer user often sufficiently identifies the person for whom content is sought that, in block 204, the identity of the person can be determined. Of course, it should be appreciated that while this identification may be carried out entirely by the search engine 110, in various embodiments this step may involve an interactive exchange between the search engine and a requesting computer user in which the computer user helps differentiate between various alternatives that may correspond to a particular search string.

After having identified the entity that is the subject matter of the search query, at block 206, the search engine 110 obtains related entity data corresponding to the identified entity. According to aspects of the disclosed subject matter, related entity data includes information of other entities that are related to the identified entity. A related entity is an entity with which the identified entity is related according to some basis. For example, assume that the identified entity is a person, is an employee of Company A, and is a member of Workgroup Z. Related entities to the identified person, based on this employment relationship, would typically include “Company A” and “Workgroup Z.” Other related entities arising from this same employment relationship may include fellow co-workers. Still other entities, based on this same employment relationship, may also include other (previous) workgroups, past and present co-workers, and the like. In furtherance of the example above, the identified entity/person may also be an alumnus of particular university. Hence, the university may be a related entity to the identified person, as well as the particular college in the university where the identified person studied, the degree that was awarded, academic achievements of the identified person, fellow students, and the like. Still further, assuming that the identified person also has a passion for gardening, the identified person may be a member of a local master gardener's society and, as a result, the local master gardeners' society may be a related entity to the identified person as well as fellow members of the society.

According to aspects of the disclosed subject matter, the search engine 110 obtains related entity data from one or more related entity sources. The search engine 110 may also host or store various information regarding the identified entity and, therefore, be one of the related entity sources. For example, the search engine 110 may store user profile information corresponding to various parties and this information may include related entity information. User profile information may be based on explicitly identified information (from the identified person) as well as implicitly identified information (such as information derived from search queries, browsing history, and the like.) Social networking sites, such as social networking site 116, represent additional related entity sources. As indicated above, a social networking site enables a person, such as the identified person of the search query, to establish relationships and social networks with other entities (that includes people, organizations, activities, causes, and the like.) Of course, there may be a variety of related entity sources, each of which hosting information that may indicate a relationship between an entity and other entities, and the search engine 110 can be configured to obtained related entity data from any number of related entity sources.

It should be appreciated that at least some of the related entity information that is hosted by each of the related entity sources may comprise access-restricted information, i.e., information that is restricted to a few individuals. To resolve this, according to aspects of the disclosed subject the search engine identifies a requesting computer user and, if identified, can attempt to use the permissions afforded to the requesting computer user in obtaining the access-restricted related entity information. In various embodiments, a computer user is required to authenticate him- or herself in order to access information regarding the identified person. Other requirements may include, by way of illustration and not limitation, that the requesting computer user be logged into one or more services in order to access and/or view content that would otherwise be restricted.

As suggested above, a related entity source may associate one or more categories to an entity (such as the identified entity of a search query). Accordingly, the related entity data obtained from the related entity sources may also include category data. Category data (both in regard to the set of potential relationships defined by the category as well as the actual relationships of a person per a category) may be advantageously used in expanding a received search query (as discussed in greater detail below.) In the example above, a related entity source may have associated various categories with the identified person including “Employee,” “Alumnus,” and “Gardener.” Moreover, each of the related entity sources may maintain category information that defines what is meant to be associated with the category. This category information often includes a list of potential, though not necessarily required, relationships that may exists between a first entity belonging to a specific category (such as the identified person) and other entities. The “Employee” category may define a set of potential relationships as including “employer,” “work group,” “current manager,” “direct reports,” “co-worker,” and the like. Correspondingly, each entity that is categorized as an “Employee” could have relationships with other entities as defined by the set of potential relationships. Of course, while a category that defines a set of potential relationships, an entity of a given category is not necessarily required to be related to other entities based on each and every potential relationship. Further still, a given entity, such as an entity corresponding to a person of a search query, may be associated with a plurality of categories. In addition to defined categories, categories may also be inferred. For example, an employee may be interested in former work performed previously at a company such that an inferred category is “co-worker.”

At block 208, a search model is identified/determined for generating the expanded search query. This search model includes information for weighting various elements (terms and phrases) of the expanded search query to improve search results. Applying a search model to the expanded search query recognizes, at least in part, that not all query terms of the expanded search query are equal, i.e., some query terms are more important in identifying relevant search content for the identified entity than others. For example, when the search query is directed to a person (i.e., the identified entity is a person) and that person is not a celebrity or famous, then weighting terms regarding employment and education tend to provide better search results. On the other hand, well known entities (including well known people/celebrities) are so commonly located in network-accessible content that it may be advantageous to not weight some factors. In short, depending on the identified entity and the intent of the search query with regard to the identified entity, a search model is generates.

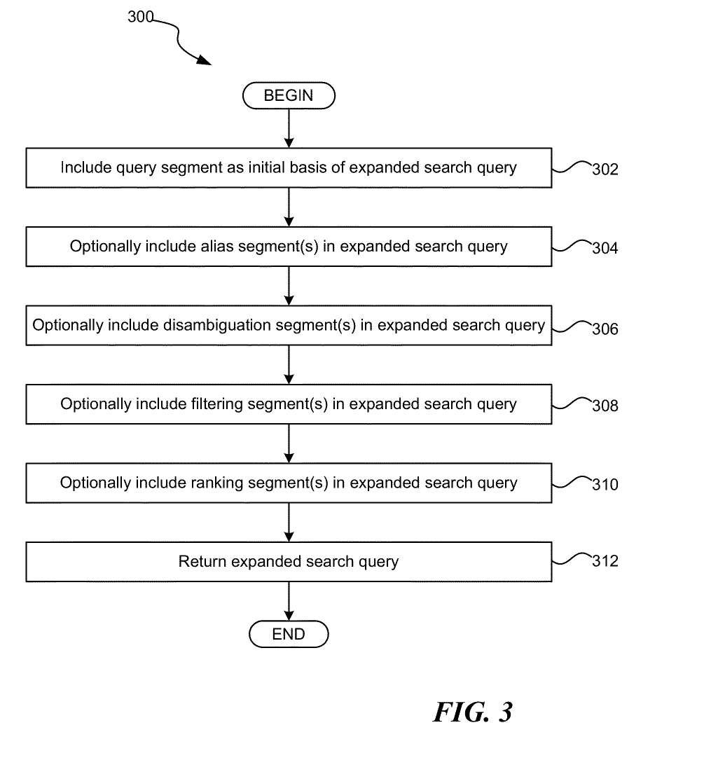

At block 210, an expanded search query is generated according to the determined search model for the identified entity. Generating an expanded search query is discussed in greater detail in regard to FIG. 3. Turning to FIG. 3, FIG. 3 is a flow diagram illustrating an exemplary routine 300 for generating an expanded search query according to related entity data obtained from related entity sources. At block 302, a query segment is included as the basis of an expanded search query. The query segment includes the identified entity of the search query as well as other query terms that may have been included in the search query.

At block 304, an alias segment is optionally added to the expanded search query. An alias segment includes aliases, pseudonyms, synonyms, and the like (all generally referred to as aliases) which are associated with identified entity. At least one purpose of the alias segment (or alias segments) is to expand the terms that will be used to locate content related and relevant to the identified entity. The alias segment may also be populated with query terms and phrases based on the intent of the computer user. While not exclusively, at least some of the aliases are identified in the obtained related entity data and category data. By way of example, assuming that the identified entity is “Microsoft Corporation,” suitable aliases and/or synonymous terms of the user's intent may include (by way of illustration) “Microsoft,” “MSFT,” “Steve Ballmer,” “Bill Gates.” In this regard, as both the current CEO of Microsoft (Steve Ballmer) and the prior CEO and founder (Bill Gates) are so closely associated with Microsoft Corporation that content which makes reference to either of these gentlemen would very likely be content related and/or relevant to Microsoft Corporation.

Of course, as indicated above, the alias segment is an optional segment. There may be instances of search queries where the identified entity is so well known and prominent that including an alias segment would only add “noise” to the potential search results. The determination to add an alias segment may be controlled by the search model that was determined for the identified entity. For example, the search model may indicate that the identified entity is well known or popular, such that any additional aliases would only add noise. Depending on the specific identified entity (as well as the intent of the search query with regard to the identified entity), the search model may include information directing the process to include an alias segment or not.

At block 306, an optional disambiguation segment may be added to the expanded search query. A disambiguation segment includes terms that help to disambiguate the identified entity from other entities that may share the same or similar names. In contrast to the alias segment, the disambiguation segment operates to limit the number of search results that are located according to the name of identified entity. For example, assuming that a search query was “Bing” and the identified entity corresponds to the online service provided by Microsoft, in order to differentiate between Detroit Mayor Dave Bing, the entertainer Bing Crosby, and the online service from Microsoft. As with the alias segment, at least some of the various terms used in the disambiguation segment are obtained from the related entity data and category data.

To illustrate the effect of the disambiguation segment reference is made to FIGS. 4A and 4B. FIG. 4A illustrates an exemplary search results page of results directed to the search query, “Bing.” Assuming that the intent of the search query was to discover search results regarding Microsoft's Bing search engine, one can be see that without disambiguation terms a substantial number (in this case 50%) of search results are irrelevant, such as results 402-406. However, with reference to FIG. 4B, by including disambiguation terms in an expanded search query (such as, for illustration purposes, “search engine” and “Microsoft”), an improved percentage (in this case 100%) of relevant search results are discovered and returned.

As with the alias segment, the disambiguation segment is an optional segment to be added to the expanded search query as guided by the search model. In determining the search model, consideration is made with regard to the popularity (or obscurity) of the identified entity, whether there are other entities that have the same or similar names, the uniqueness of the name, and the like. Indeed, in instances when an identified entity is famous, renown, a celebrity, or simply unique a disambiguation segment may not be necessary and, in fact, may restrict out results that would be considered relevant.

With reference again to FIG. 3, at block 308, a filter segment is optionally included in the expanded search query. A filter segment is used to narrow down the results to those that correspond to the search query's intent. Filter segments may include both positive filter terms (i.e., “whitelist” terms that are strongly associated with a specific entity) as well as negative filter terms (i.e., “blacklist” terms that are strongly not associated with a specific entity). While both the disambiguation and filter segments act to limit the results that are determined to be relevant to the search query, generally speaking a disambiguation segment differentiates between entities that share the same name, whereas the filter segment includes terms that limit the scope of relevant search results that include the identified entity. Of course, there are times that a disambiguation segment also acts as a filter segment just as a filter segment may also serve as a disambiguation segment. Often, though not required, query terms from the original search query can be included in the filter segment (as well as the disambiguation segment). For example, if the search query was “Amazon Prime,” with reference to the membership program at Amazon.com, the term “Prime” may be included in the filter segment to limit the scope of relevant search results that touch on the company, Amazon.com. Additional terms may include (by way of illustration), “prime membership,” “prime instant video,” “two-day free shipping,” and the like. Filtering terms/elements will also be derived from the related entity data, including category data. As with the other optional segments, one or more filter segments may be included in the expanded search query dependent on the search model for the particular search query.

At block 310, a ranking segment is optionally included in the expanded search query. Unlike the alias, disambiguation, and filtering sections, the ranking section does not affect the scope of the content that is identified for the expanded search query. Instead, the ranking segment provides the ability to control the relevancy score of content/search results that match the search query (or more particularly, that match the expanded search query). Certain search results may be ranking higher or lower by the inclusion of the optional ranking segment. Use of the ranking segment is applied according to the determined search model. After adding the various segments to the expanded search query, at block 312 the expanded search query is returned and the routine 300 terminates.

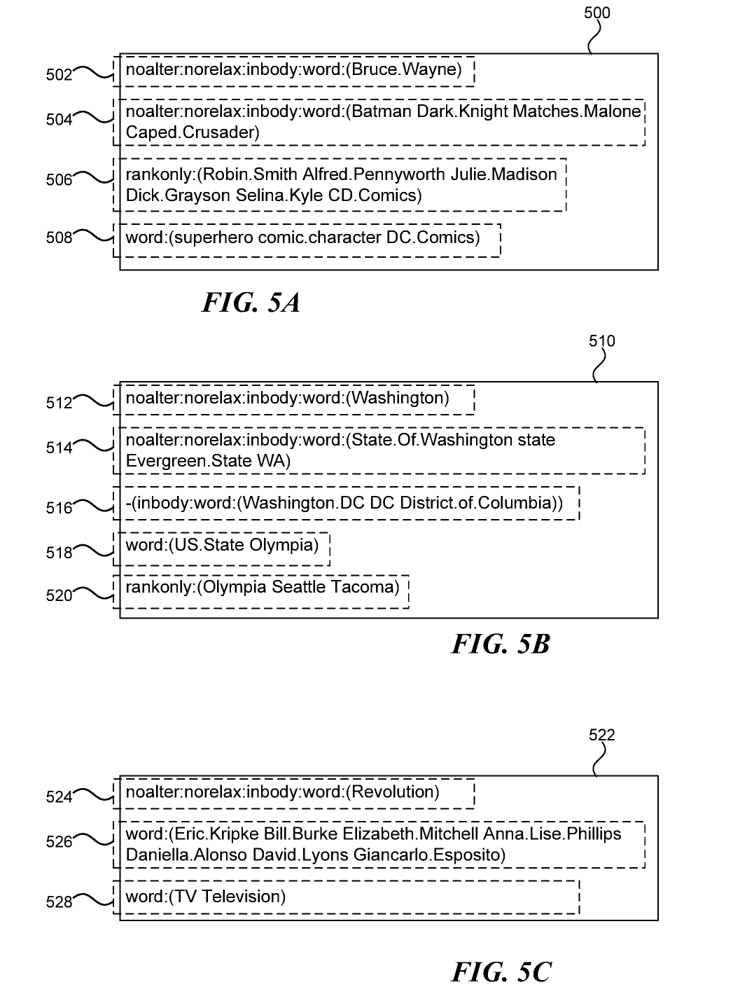

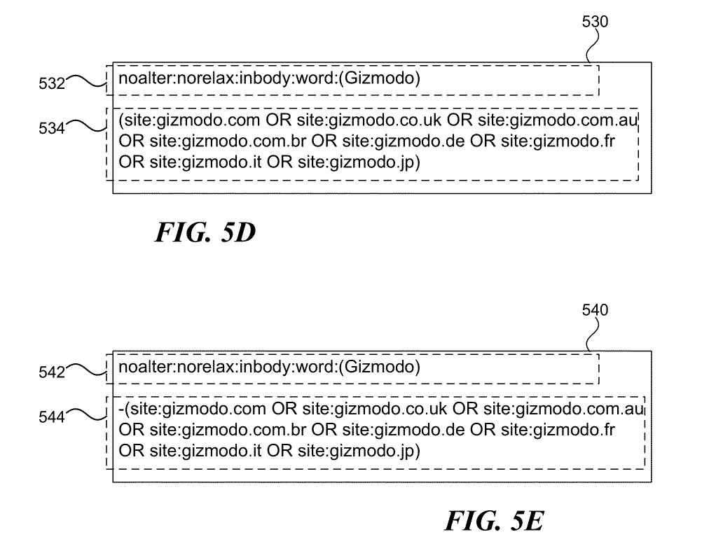

By way of examples, FIGS. 5A-5E illustrate various expanded search queries. In FIG. 5A, the exemplary expanded search query 500 corresponds to the search query “Bruce Wayne,” corresponding to the fictitious comic book character. As can be seen, the expanded search query 500 includes a query segment 502 as well as an alias segment 504, and two filter segments 506-508. As seen in filter segment 508, various category information (“superhero” and “comic.character”) is included.

The exemplary expanded search queries illustrated in FIGS. 5A-5E are presented in an illustrative syntax that includes operators such as “noalter:”, “norelax:”, “inbody:,” “word:,” “-,” “rankonly:”, “site:”, and “OR”. It should be appreciated that this syntax is an illustrative syntax that may be used by a search engine in retrieving search results, but should not be viewed as a required syntax. Nor should the listed operators be viewed as an exhaustive list that may be used in generating an expanded search query.

Regarding the illustrative operators, the “word:” operator indicates to the search engine, such as search engine 110, to consider content as matching the expanded search query if any one of the words between the parentheses is found in the content (or part of the content as may be restricted by another operator). In other words, in various embodiments the “word:” operator may be viewed as functioning as a type of Boolean operator: False or 0 if none of the words or terms between the parenthesis are matched, and True or 1 if one or more words or terms between the parenthesis are matched. In an alternative implementation, the “word:” operator may function as a “max” operator: returning the maximum ranking/value for the matched token/phrase having the highest ranking/value of all of the matched tokens or phrases in the parenthesis.

The “noalter:” operator instructs the search engine to not alter the spelling of the terms/phrases between the parenthesis. This prevents the search engine from performing spelling correction on the terms as well as expanding the query terms/phrases to similar terms. The “norelax:” operator indicates that all terms of a multi-term phrase must be present for a match. For example, the phrase “State.Of.Washington” is a multi-term phrase and, under the “norelax:” operator all of the terms must be found adjacent and the presented order to be considered a match. The “inbody:” operator limits the search engine to finding a match for any of the phrases to the “body” of the content (as opposed to metadata, headers, etc.). The “-” operator indicates that the search engine should invert the results of the operators in the parenthesis. This serves to restrict or filter out various results that are not to be matched. The “rankonly:” operator indicates that if any of the terms/phrases in the parenthesis are found, the fact that they are matched should be used in ranking purposes only, and not for identifying a document/content as matching the expanded search query. The “site:” operator serves to limit the matching content to specified sites or, in conjunction with a “-” operator, to restrict matching content from specified sites. The “OR” operator functions as a Boolean OR operator.

FIG. 5B illustrates an expanded search query 510 corresponding to the search query “Washington.” Assuming that the entity was correctly identified as corresponding to the state of Washington, the expanded search query 510 includes a search query segment 512, two disambiguation segments 514 and 516, a filter segment 518, and a ranking segment 520. Regarding the disambiguation segment, in this example the symbol “-” functions as a NOT operator such that if the terms are found in the content then then content would not be considered a match for the expanded search query.

FIG. 5C illustrates an expanded search query 522 corresponding to the search query “Revolution,” and particularly in regard to the television series “Revolution.” This exemplary expanded search query includes a search query segment 524, a filter segment 526, and a disambiguation segment 528. Note that the disambiguation segment 528 includes category information regarding a television show.

FIG. 5D illustrates an expanded search query 530 corresponding to the search query “Gizmodo,” particularly in regard to news offered by the technology site, Gizmodo.com, and its international sites. In this case, in addition the search query segment 532, as Gizmodo is quite unique what remains is a filter segment 534 to filter/limit the scope of content to that which can be obtained from any one of Gizmodo's web sites. In contrast to expanded search query 530, FIG. 5E illustrates exemplary expanded search query 540 corresponding to the search query “Gizmodo,” particularly in regard to news regarding Gizmodo and limited to hosted by sites other than a Gizmodo site. In this example, the expanded search query 540 includes the search query segment 542 and a filter segment 544 to restrict out all of the Gizmodo sites.

In contrast to the expanded search query 530 of FIG. 5D, the expanded search query of FIG. 5E in which news regarding the technology site, Gizmodo.com, as indicated by the search query segment 542, but that does not originate from any of the Gimodo sites. As can be seen, the use of the “-” operator in the filter segment 544 restricts out news that originates from any of the Gizmodo sites.

Generally speaking and as guided by the search model, an expanded query incorporates the related entity information, including category information, into the expanded search query to disambiguated, expanded, filter, and/or rank matching search results from content that the search engine has maintained in a content store.

Returning again to FIG. 2, at block 212 search results are obtained according to the expanded search query. Obtaining search results according to a search query, in this case an expanded search query, is known in the art. After obtaining search results, at block 214 a search results presentation is generated. As will be readily recognized, one or more search results pages are typically generated according to the obtained search results as the search results presentation, with those results scoring the highest being presented in the first pages of the presentation. Generating a search results presentation is also known in the art. At block 216, after generating the search results presentation, at least a portion of the presentation is returned to the requesting computer user in response to the search query. Thereafter, the routine 200 terminates.

While not displayed in routine 200, additional steps may be taken after the results are returned to the computer user. By way of illustration and not limitation, one or more processes on the computer user's device may monitor the computer user's activity with regard to the results provided, e.g., which references (hyperlinks) the computer user followed, which were avoided, how long the computer user spent with some content vs. other content, and the like. By monitoring the computer user's activity and submitting it to the search engine, inferences may be made regarding specific people and/or entities such that subsequent queries may take these inferences into account. Indeed, some or all of the inferences, both for and against specific results, may be used to form the search models discussed above.

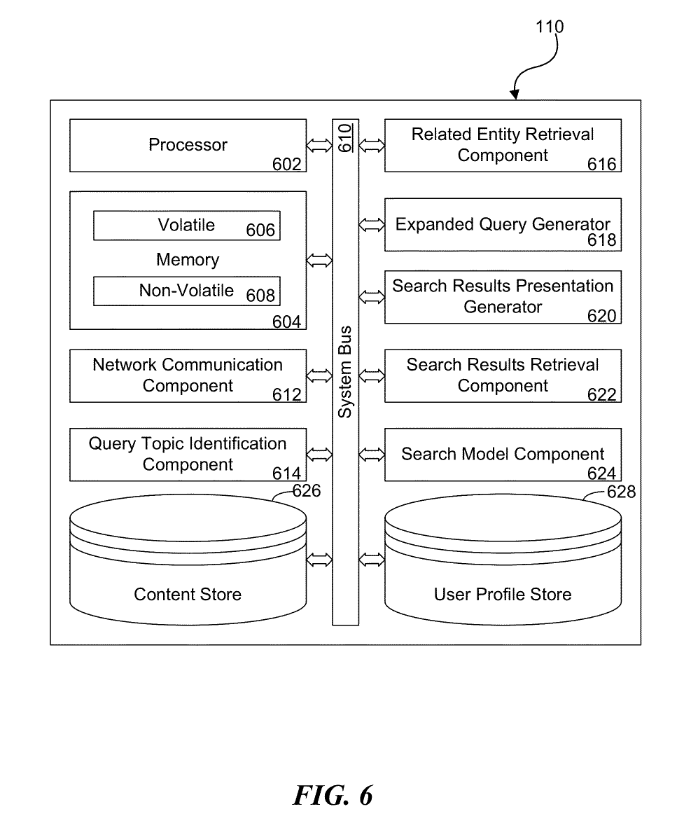

Regarding routines 200 and 300, while these routines are expressed in regard to discrete steps, these steps should be viewed as being logical in nature and may or may not correspond to any one or multiple discrete steps of a particular implementation. Nor should the order in which these steps are presented in the various routines be construed as the only order in which the steps may be carried out. Moreover, while these routines include various novel features of the disclosed subject matter, other steps (not listed) may also be carried out in the execution of the routines. Further, those skilled in the art will appreciate that logical steps of these routines may be combined together or be comprised of multiple steps. Steps of routines 200 and 300 may be carried out in parallel or in series, or pre-computed. Often, but not exclusively, the functionality of the various routines is embodied in software (e.g., applications, system services, libraries, and the like) that is executed on computer hardware and/or systems as described below in regard to FIG. 6. In various embodiments, all or some of the various routines may also be embodied in hardware modules, including system on chips, on a computer system.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions stored on the computer-readable storage devices are executed, they carry out various steps, methods and/or functionality, including those steps, methods, and routines described above in regard to routines 200 and 300. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

Turning now to FIG. 6, FIG. 6 is a block diagram illustrating exemplary components of a search engine 110 suitably configured to provide improved results in response to a search query from a computer user. As shown in FIG. 6, the search engine 110 includes a processor 602 (or processing unit) and a memory 604 interconnected by way of a system bus 610. As those skilled in the art will appreciated, memory 604 typically (but not always) comprises both volatile memory 606 and non-volatile memory 608. Volatile memory 606 retains or stores information so long as the memory is supplied with power. In contrast, non-volatile memory 608 is capable of storing (or persisting) information even when a power supply is not available. Generally speaking, RAM and CPU cache memory are examples of volatile memory whereas ROM and memory cards are examples of non-volatile memory.

The processor 602 executes instructions retrieved from the memory 604 in carrying out various functions, particularly in responding to search queries with improved results through query expansion (also referred to as semantic entity traversal) as described above in regard to the process defined in FIG. 2. The processor 602 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; game consoles, and the like.

The system bus 610 provides an interface for the various components to inter-communicate. The system bus 610 can be of any of several types of bus structures that can interconnect the various components (including both internal and external components). The search engine 110 further includes a network communication component 612 for interconnecting the network site with other computers (including, but not limited to, user computers such as user computers 102-106, other network sites including network sites 112-116) as well as other devices on a computer network 108. The network communication component 612 may be configured to communicate with other devices and services on an external network, such as network 108, via a wired connection, a wireless connection, or both.

The search engine 110 also includes query topic identification component 614 that is configured to identify the subject matter of the search query, such as a person identified in the search query, as described above. Also included in the search engine 110 is a related entity retrieval component 616. The related entity retrieval component 616 obtains related entity data corresponding to related entities of the identified person (or, more generally, related entities of the subject matter of the search query). As previously mentioned, the related entity data includes related entities, categories associated with the identified person, as well as category data corresponding to the associated categories. The related entity retrieval component 616 obtains the related entity data from related entity sources as described above in regard to FIG. 2. An expanded query generator 618 generates an expanded search query from the search query received from a computer user according to the related entity data obtained by the related entity retrieval component 616.

A search results retrieval component is configured to obtain search results from a content store 626 according to the expanded search query generated by the expanded query component 618. A search model component 624 is configured to select a search model (as described above) and apply the search model to the obtained search results. The search results presentation generator 620 generates a search results presentation, typically including one or more search results pages, for presentation to the requesting computer user in response to the search query.

Those skilled in the art will appreciate that the various components of the search engine 110 of FIG. 6 described above may be implemented as executable software modules within the computer systems, as hardware modules (including SoCs—system on a chip), or a combination of the two. Moreover, each of the various components may be implemented as an independent, cooperative process or device, operating in conjunction with one or more computer systems. It should be further appreciated, of course, that the various components described above in regard to the search engine 110 should be viewed as logical components for carrying out the various described functions. As those skilled in the art appreciate, logical components (or subsystems) may or may not correspond directly, in a one-to-one manner, to actual, discrete components. In an actual embodiment, the various components of each computer system may be combined together or broke up across multiple actual components and/or implemented as cooperative processes on a computer network 108.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for providing improved search results to a search query, the method comprising:
receiving a search query;
identifying an entity of the search query;
obtaining related entity data, wherein the related entity data comprising a plurality of related entities that are related to the identified entity;
determining a search model for obtaining search results for the identified entity;
generating an expanded search query according to the received search query, the related entity data, and the search model, wherein the expanded search query comprises a search query segment and at least one of a disambiguation segment, an alias segment, and a filter segment, wherein the search query segment includes a query term for the identified entity, and wherein the at least one of the disambiguation segment, the alias segment, and the filter segment includes a query term not included in the received search query;
obtaining search results for the expanded search query;
generating a search results presentation according to the obtained search results; and
providing the search results presentation in response to the received search query.

2. The computer-implemented method of claim 1, wherein a disambiguation segment comprises one or more query terms for disambiguating the identified entity from other entities that have the same textual representation as the identified entity in the received search query, and wherein at least one of the one or more query terms for disambiguating the identified entity from other entities is a query term not included in the received search query.

3. The computer-implemented method of claim 1, wherein an alias segment comprises one or more query terms that are synonyms or aliases of the identified entity, and wherein at least one of the one or more query terms that are synonyms or aliases of the identified entity is a query term not included in the received search query.

4. The computer-implemented method of claim 1, wherein a filter segment comprises one or more query terms that narrow the scope of content that matches the identified entity according to a determined intent of the received search query, and wherein at least one of the one or more query terms that narrow the scope of content that matches the identified entity is a query term not included in the received search query.

5. The computer-implemented method of claim 1, wherein the expanded search query comprises a search query segment and at least one of a disambiguation segment, an alias segment, a filter segment, and a ranking segment, and wherein the at least one of the disambiguation segment, the alias segment, the filter segment, and the ranking segment includes a query term not included in the received search query; and
wherein a ranking segment comprises one or more query terms that modify the ranking score of content that matches the identified entity and that includes the one or more query terms.

6. The computer-implemented method of claim 1, where the at least one query term of the disambiguation segment, the alias segment, and the filter segment is a query term corresponding to a related entity from the related entity data.

7. The computer-implemented method of claim 1, wherein the related entity data further comprises category data identifying one or more categories of the identified entity, and wherein the identified entity is related to at least one of the plurality of related entities according to a category of the one or more categories.

8. The computer-implemented method of claim 7, wherein the category data further includes, for each of the one or more categories of the identified entity, a plurality of category entities defining the types of relationships that an entity of the category may have with other entities.

9. The computer-implemented method of claim 7, wherein determining a search model for obtaining search results for the identified entity comprises determining the search model according to the one or more categories of the identified entity.

10. A computer-readable medium bearing computer-executable instructions which, when executed on a computing system comprising at least a processor executing the instructions retrieved from the medium, carry out a method for providing improved search results to a search query, the method comprising:
receiving a search query;
identifying an entity of the search query;
obtaining related entity data, wherein the related entity data comprising a plurality of related entities that are related to the identified entity;
determining a search model for obtaining search results for the identified entity;
generating an expanded search query according to the received search query, the related entity data, and the search model, wherein the expanded search query comprises a search query segment and at least one of a disambiguation segment, an alias segment, and a filter segment, wherein the search query segment includes a query term for the identified entity, and wherein the at least one of the disambiguation segment, the alias segment, and the filter segment includes a query term not included in the received search query;
obtaining search results for the expanded search query;
generating a search results presentation according to the obtained search results; and
providing the search results presentation in response to the received search query.

11. The computer-readable medium of claim 10, wherein a disambiguation segment comprises one or more query terms for disambiguating the identified entity from other entities that have the same textual representation as the identified entity in the received search query, and wherein at least one of the one or more query terms for disambiguating the identified entity from other entities is a query term not included in the received search query.

12. The computer-readable medium of claim 10, wherein an alias segment comprises one or more query terms that are synonyms or aliases of the identified entity, and wherein at least one of the one or more query terms that are synonyms or aliases of the identified entity is a query term not included in the received search query.

13. The computer-readable medium of claim 10, wherein a filter segment comprises one or more query terms that narrow the scope of content that matches the identified entity according to a determined intent of the received search query, and wherein at least one of the one or more query terms that narrow the scope of content that matches the identified entity is a query term not included in the received search query.

14. The computer-readable medium of claim 10, wherein the expanded search query comprises a search query segment and at least one of a disambiguation segment, an alias segment, a filter segment, and a ranking segment, and wherein the at least one of the disambiguation segment, the alias segment, the filter segment, and the ranking segment includes a query term not included in the received search query; and
wherein a ranking segment comprises one or more query terms that modify the ranking score of content that matches the identified entity and that includes the one or more query terms.

15. The computer-readable medium of claim 10, where the at least one query term of the disambiguation segment, the alias segment, and the filter segment is a query term corresponding to a related entity from the related entity data; and
wherein identifying an entity of the search query comprises identifying an entity of the search query according to general and specific information relating to a requesting computer user.

16. The computer-readable medium of claim 10, wherein the related entity data further comprises category data identifying one or more categories of the identified entity, and wherein the identified entity is related to at least one of the plurality of related entities according to a category of the one or more categories.

17. The computer-readable medium of claim 16, wherein the category data further includes, for each of the one or more categories of the identified entity, a plurality of category entities defining the types of relationships that an entity of the category may have with other entities.

18. The computer-readable medium of claim 16, wherein determining a search model for obtaining search results for the identified entity comprises determining the search model according to the one or more categories of the identified entity.

19. A computer system for generating an expanded search query for a received search query, the system comprising a processor and a memory, wherein the processor executes instructions stored in the memory as part of or in conjunction with additional components, the additional components comprising:
entity identification component that identifies an entity from the query terms of the received search query;
a related entity retrieval component for obtaining related entity data of entities related to the identified entity from an entity identification component;
a search model determination component for determining a search model for the identified entity; and
an expanded query generator to generate an expanded search query according to the received search query, the related entity data, and the search model, wherein:
the expanded search query comprises a search query segment and at least one of a disambiguation segment, an alias segment, and a filter segment;
the search query segment includes a query term for the identified entity; and
wherein the at least one of the disambiguation segment, the alias segment, and the filter segment includes a query term not included in the received search query.

20. The computer system of claim 19 further comprising:
a search results component for identifying a set of search results according to an expanded search query from the expanded query generator;
a search results presentation component for generating a search results presentation from a set of search results from the search results component; and
a network communication component for receiving the received search query over a network and for providing a search results presentation from the search results presentation component in response to receiving the received search query.
